(19) United States
(12) Patent Application Publication
(10) Pub. No.: US 2023/0158881 A1
(43) Pub. Date: May 25, 2023

(54) HYBRID DRIVE SYSTEM COMPRISING A MULTI-SPEED TRANSMISSION DEVICE; AND MOTOR VEHICLE

(71) Applicant: Schaeffler Technologies AG & Co. KG, Herzogenaurach (DE)

(72) Inventors: Laurent Bayoux, Strasbourg (FR); Dierk Reitz, Baden-Baden (DE)

(73) Assignee: Schaeffler Technologies AG & Co. KG, Herzogenaurach (DE)

(21) Appl. No.: 17/916,108

(22) PCT Filed: Mar. 10, 2021
(86) PCT No.: PCT/DE2021/100245

§ 371 Date: Sep. 30, 2022

(30) Foreign Application Priority Data
Apr. 2, 2020 (DE) 10 2020 109 237.7

(51) Int. Cl. B60K 6/40; B60K 6/547; F16H 37/08; B60K 6/26; B60K 6/24; B60K 6/365; B60K 6/387; B60K 6/52; B60K 6/442

(52) U.S. Cl. CPC B60K 6/40; B60K 6/547; F16H 37/0806; B60K 6/26; B60K 6/24; B60K 6/365; B60K 6/387; B60K 6/52; B60K 6/442; B60Y 2200/92; B60Y 2400/80; B60Y 2400/73; B60K 2006/381

(57) ABSTRACT

A drive system for a hybrid motor vehicle includes an internal combustion engine, a first electric machine and a second electric machine. A rotor shaft of the first electric machine is rotationally coupled to an output shaft of the internal combustion engine and is arranged coaxially to said output shaft. A rotor shaft of the second electric machine is arranged coaxially to the output shaft and can be uncoupled from the rotor shaft of the first electric machine via a clutch. At least one differential transmission has at least two outputs. The output shaft is connected to the rotor shaft of the first electric machine via a fixed transmission stage, and the rotor shaft of the second electric machine is coupled to an input of the at least one differential transmission via a two-speed transmission device.

### CROSS-REFERENCE TO RELATED APPLICATIONS

This application is the U.S. National Phase of PCT Appln. No. PCT/DE2021/100245 filed Mar. 10, 2021, which claims priority to DE 10 2020 109 237.7 filed Apr. 2, 2020, the entire disclosures of which are incorporated by reference herein.

### TECHNICAL FIELD

The disclosure relates to a drive system for a hybrid motor vehicle, such as a car, truck, bus or other utility vehicle, comprising an internal combustion engine, a first electric machine, the rotor shaft of which is permanently rotationally coupled to an output shaft of the internal combustion engine and is arranged coaxially to said output shaft, a second electric machine, the rotor shaft of which is also arranged coaxially to the output shaft and can be uncoupled from the rotor shaft of the first electric machine via a clutch, and at least one differential transmission that has two outputs. Furthermore, the disclosure relates to a motor vehicle comprising this drive system.

### BACKGROUND

Generic drive systems are already sufficiently known in the prior art. In this respect, WO 2007/004356 A1, for example, discloses a drive device for hybrid vehicles with two electric motors. Further prior art is known from EP 2 284 030 B1 and U.S. Pat. No. 8,894,525 B2.

However, regarding the drive systems known from the prior art, it has been shown that these are often relatively large in size and complex in structure. In particular, shift transmissions with higher complexity are usually used, which, apart from the fact that they take up additional installation space, also have a detrimental effect on the effort required to assemble the drive system.

### SUMMARY

It is therefore the object of the present disclosure to eliminate the disadvantages known from the prior art and, in particular, to provide an efficiently operating drive system which has the simplest structure possible and saves installation space.

According to the disclosure, this is achieved in that the rotor shaft of the second electric machine is (rotationally) coupled/connected to an input of the at least one differential transmission via a two-speed transmission device (i.e. having no more or less than two gears).

Thus, on the one hand, the connection between the rotor shaft of the second electric machine and the differential transmission is realized using a transmission device that is as simple as possible as well as compact, and, on the other hand, the transmission device for utilizing different gear ratios can be switched to several operating modes for efficient operation of the drive system.

Further embodiments are claimed and explained in more detail below.

Accordingly, it is further advantageous if the fixed transmission stage is designed as a planetary transmission stage. This allows a particularly compact axial design.

In this context, it is also expedient if a planetary carrier of the fixed transmission stage is permanently connected to the output shaft of the internal combustion engine and/or a sun gear of the fixed transmission stage is connected to the rotor shaft of the first electric machine. A ring gear of the fixed transmission stage is further preferably supported fixed to the housing. This results in a transmission stage that is as simple as possible and sufficiently robust for the torque to be transmitted.

The fixed transmission stage is advantageously designed in such a way that it gears a speed to be transmitted from the output shaft of the internal combustion engine to the rotor shaft of the first electric machine into high. This means that the most efficient structure possible has been selected.

Furthermore, it is advantageous if the clutch is spatially arranged between rotors of the two electric machines. This also allows the clutch to be mounted in the most space-saving manner possible.

It is also useful if the transmission device is designed as a planetary transmission and preferably has two planetary transmission stages. This allows an even more compact axial design.

The transmission device is advantageously designed in such a way that it gears a speed to be transmitted from the rotor shaft of the second electric machine to an output shaft of the transmission device (in both gears) to low. This means that the most efficient structure possible has been selected.

It is also advantageous if a first switching element of the transmission device is designed as a brake and/or is operatively inserted between a support region fixed to the housing and a ring gear of one of the planetary transmission stages. This allows the first switching element to be made as compact as possible and to be arranged in a manner that saves installation space.

In this context, it is also useful if a second switching element of the transmission device is designed as a clutch and/or is operatively inserted between an input shaft and a ring gear of one of the planetary transmission stages. This allows the second switching element to be made as compact as possible and to be arranged in a manner that saves installation space.

It is also advantageous if an output shaft of the transmission device is rotationally coupled/connected to an input of a first differential transmission via a cardan shaft. This type of coupling results in further savings in installation space.

In this respect, it is also useful if the cardan shaft is connected to the input of the first differential transmission via a gearing stage. The gearing stage is preferably implemented as a bevel gearing stage.

If the output shaft of the transmission device is connected to an input of a second differential transmission via at least one gearing stage as an alternative or in addition to its coupling to the first differential transmission, either a front-wheel drive, rear-wheel drive or all-wheel drive can be realized in a simple manner.

In this respect, it is further expedient if the output shaft of the transmission device is rotationally coupled via a first gearing stage to an intermediate shaft arranged parallel thereto, which intermediate shaft is further connected to the input of the second differential transmission. This results in a drive system that is as simple as possible and saves installation space.

It is also advantageous if the intermediate shaft is connected to the input of the second differential transmission via a second gearing stage. The second gearing stage is further preferably implemented as a bevel gearing stage. This in turn results in a drive system that is as simple as possible and saves installation space.

Furthermore, it has proven advantageous if the output shaft of the internal combustion engine is connected to the rotor shaft of the first electric machine via a torsional vibration damper, which is preferably implemented as a dual-mass flywheel. This cleverly couples the internal combustion engine to the rest of the drive train in a damped manner in the particular operating mode.

Furthermore, the disclosure relates to a motor vehicle with a drive system according to the disclosure according to at least one of the embodiments described above, wherein the output shaft of the internal combustion engine is arranged parallel or coaxial to a vehicle longitudinal axis of the motor vehicle.

In this regard, it is also advantageous if each output of the first differential transmission is connected to a rear wheel (of the motor vehicle) for conjoint rotation and/or each output of the second differential transmission is connected to a front wheel (of the motor vehicle) for conjoint rotation. This results in the most direct possible coupling of the drive system with the wheels of a front axle or a rear axle.

If the internal combustion engine is arranged in front of the front wheels along the vehicle longitudinal axis and as seen in a main direction of travel of the motor vehicle, this results in an efficient application of the drive system with a front-longitudinal design of the internal combustion engine.

### BRIEF DESCRIPTION OF THE DRAWINGS

The disclosure will now be explained in more detail with reference to figures, in which context various exemplary embodiments are also shown.

In the figures:

FIG. 1 shows a schematic longitudinal sectional view of a drive system according to the disclosure according to a first embodiment, in which an output shaft of an internal combustion engine and two rotor shafts of two electric machines are arranged coaxially to one another and one of the rotor shafts is coupled to the output shaft of the internal combustion engine via a fixed transmission stage and the other of the rotor shafts is coupled to a rear wheel differential via a two-speed transmission device and a cardan shaft, and

FIG. 2 shows a schematic longitudinal sectional view of a drive system according to the disclosure according to a second embodiment, in which an output shaft of the transmission device is coupled both to the cardan shaft and, with the interposition of two gearing stages, to a second differential transmission.

### DETAILED DESCRIPTION

The figures are only schematic in nature and serve only for understanding the disclosure. The same elements are provided with the same reference signs.

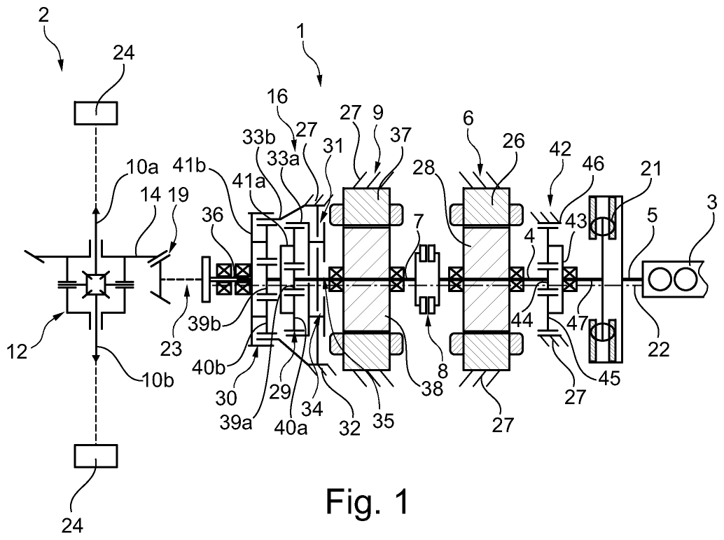

FIG. 1 illustrates the structure of a drive system 1 according to the disclosure in accordance with a first exemplary embodiment. The drive system 1 is implemented as a hybrid drive system 1 and is consequently used in a preferred area of application in a hybrid motor vehicle 2, which is schematically indicated in FIG. 1.

The drive system 1 has an internal combustion engine 3, for example in the form of a petrol or diesel engine, which is oriented with its output shaft 5 (crankshaft) along, i.e. parallel or coaxial to, an imaginary vehicle longitudinal axis 22/vehicle centerline of the motor vehicle 2. In addition, in this embodiment, the internal combustion engine 3 is arranged in front of a front axle with front wheels 25 (i.e. on a side of a front axle facing away from a rear axle with rear wheels 24) as viewed along the vehicle longitudinal axis 22.

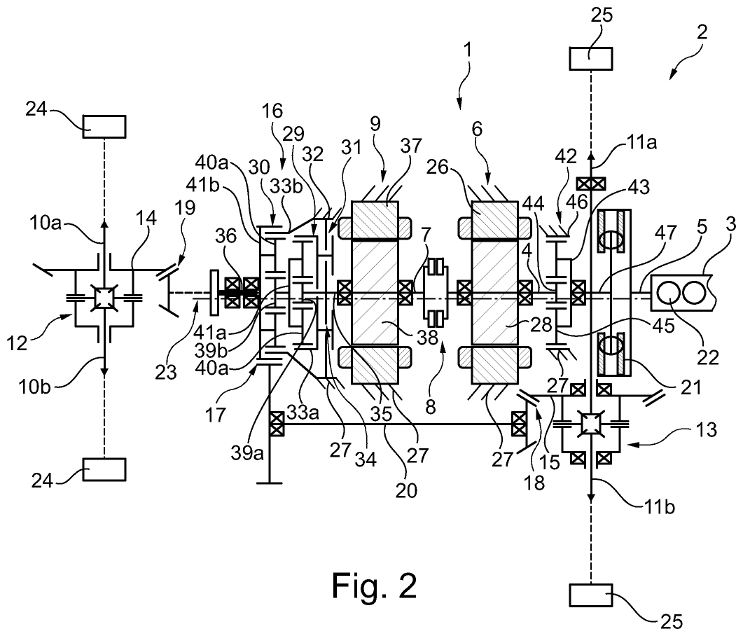

In the first exemplary embodiment according to FIG. 1, the drive system 1 serves to drive two rear wheels 24 of the rear axle of the motor vehicle 2, as described in more detail below. In further exemplary embodiments, as described below in conjunction with FIG. 2, this drive system 1 is designed alternatively for driving two front wheels 25 of a front axle of the motor vehicle 2 or even as an all-wheel drive, i.e., for driving all wheels 24, 25 of the motor vehicle 2.

The output shaft 5 of the internal combustion engine 3 is arranged coaxially with a (first) rotor shaft 4 of a first electric machine 6. The output shaft 5 is permanently rotationally coupled/connected to the first rotor shaft 4.

In this embodiment, the output shaft 5 is connected to the first rotor shaft 4 via, among other things, a torsional vibration damper 21, here in the form of a spring damper (for example a dual-mass flywheel).

Furthermore, the output shaft 5 is connected to the first rotor shaft 4 via a fixed transmission stage 42. For this purpose, the fixed transmission stage 42 is connected on the input side to a connecting shaft 47, wherein the connecting shaft 47 is further connected to a side of the torsional vibration damper 21 facing away from the output shaft 5. On the output side, the fixed transmission stage 42 is directly connected to the first rotor shaft 4.

The fixed transmission stage 42 is designed as a planetary transmission stage. One input of the fixed transmission stage 42 is formed as a (third) planetary carrier 43. A plurality of (third) planetary gears 45 are rotatably supported on the planetary carrier 45 in a typical manner. The planetary gears 45 are in meshed engagement with both a (third) sun gear 44 and a (third) ring gear 46. The sun gear 44 directly forms the output of the fixed transmission stage 42, which is further connected to the first rotor shaft 4. In this design, the ring gear 46 of the fixed transmission stage 42 is supported fixed to the housing.

The first electric machine 6 is further designed to be switchable as a generator machine in a first operating mode of the drive system 1. The first electric machine 6 has a (first) stator 26 that is fixedly received in a housing 27. Relative to the first stator 26, a (first) rotor 28 of the first electric machine 6 is rotatably supported. The first rotor 28 is connected to the first rotor shaft 4 for conjoint rotation. The first rotor shaft 4 is supported in the housing 27.

In addition to the first electric machine 6, a second electric machine 9 is present. In the first operating mode of the drive system 1, the second electric machine 9 serves as a drive machine/traction machine. The second electric machine 9 also has a (second) stator 37 received fixed to the housing and a (second) rotor 38 received rotatably relative to the second stator 37. The second rotor 38 is directly connected to a second rotor shaft 7 associated with the second electric machine 9. The second rotor shaft 7 is also supported in the housing 27. The second rotor shaft 7 is arranged coaxially with the first rotor shaft 4 and the output shaft 5. Accordingly, the output shaft 5, the first rotor shaft 4 and the second rotor shaft 7 are arranged coaxially and in a row to one another.

A clutch 8, preferably in the form of a friction clutch, is operatively inserted between the two rotor shafts 4, 7. The clutch 8 is used to selectively couple or decouple the two rotor shafts 4, 7 to or from one another. In a closed position of the clutch 8, the two rotor shafts 4, 7 are connected to one another for conjoint rotation; in an open position of the clutch 8, the two rotor shafts 4, 7 are decoupled from one another/freely rotatable relative to one another. It can be seen that the clutch 8 is spatially arranged between the two rotors 28, 38 of the two electric machines 6, 9.

In addition, the second rotor shaft 7 is permanently rotationally coupled/connected to an input 14 of a first differential gear 12 (here a rear wheel differential) via a two-speed transmission device 16, which has exactly two gears (implementing different gear ratios).

In the first exemplary embodiment, a cardan shaft 23 is used to implement the rotary connection of an output shaft 36 of the transmission device 16 to the input 14 of the first differential transmission 12. The cardan shaft 23 is connected to an end of the output shaft 36 facing away from the second electric machine 9. The cardan shaft 23 is coupled to the input 14 of the first differential transmission 12 via a (third) gearing stage 19. The input 14 is implemented in a typical manner as an input gear. In this embodiment, the input 14 is implemented as a bevel gear and the third gearing stage 19 is thus designed as a bevel gearing.

Two outputs 10a, 10b of the first differential transmission 12, each connected to a rear wheel 24 in this first exemplary embodiment, are arranged obliquely, namely substantially perpendicularly, to the output shaft 5 of the internal combustion engine 3 and the rotor shafts 4, 7.

With the clutch 8 closed, the internal combustion engine 3 thus drives the motor vehicle 2 directly in a second operating mode (with optional drive assistance from the second electric machine 9) and by shifting one of the two gears of the transmission device 16.

With regard to the transmission device 16, it can further be seen that it has two planetary transmission stages 29, 30. A first planetary transmission stage 29 of the transmission device 16 directly forms an input shaft 35 of the transmission device 16. The input shaft 35 is connected to the second rotor shaft 7 for conjoint rotation. In addition, the input shaft 35 is directly connected to a (first) sun gear 39a of the first planetary transmission stage 29.

The first planetary transmission stage 29, in a typical manner, has a plurality of (first) planetary gears 40a arranged distributed in the circumferential direction in meshed engagement with the first sun gear 39a in addition to the first sun gear 39a, which first planetary gears 40a are further in meshed engagement with a first ring gear 33a. The first planetary gears 40a are also rotatably supported on a first planetary carrier 41a.

The second planetary transmission stage 30, which also directly forms the output shaft 36 of the transmission device 16, also has a (second) sun gear 39b, a plurality of (second) planetary gears 40b arranged distributed in the circumferential direction and in meshed engagement with the second sun gear 39b, and a (second) ring gear 33b in turn in meshed engagement with the second planetary gears 40b. Also, the second planetary gears 40b are rotatably supported on a (second) planetary carrier 41b.

In this embodiment, the first planetary carrier 41a is connected to the second sun gear 39b for conjoint rotation. The second planetary carrier 41b again transitions directly into the output shaft 36 or is directly connected to this output shaft 36 for conjoint rotation.

Two switching elements 31, 34 are provided for switching the transmission device 16 between its two different gears. In this embodiment, a first switching element 31 is designed as a brake and is thus operatively inserted between a support region 32 fixed to the housing and a component of the transmission device 16. In this embodiment, the first switching element 31 is operatively inserted between the support region 32 fixed to the housing and the first ring gear 33a. In an activated position/state of the first switching element 31, the first ring gear 33a is thus supported fixed to the housing, whereas in a deactivated position/state of the first switching element 31, it is free to rotate relative to the housing 27.

In this embodiment, a second switching element 34 is implemented as a clutch, which is realized as a friction clutch, for example. The second switching element 34 is operatively inserted between the input shaft 35 and the first ring gear 33a. Consequently, in a closed position of the second switching element 34, the input shaft 35 and the first ring gear 33a are coupled for conjoint rotation so that the first planetary transmission stage 29 rotates in the block. In an open position of the second switching element 34, the first ring gear 33a and the input shaft 35 are free to rotate relative to one another.

Furthermore, it can be seen that in this embodiment the second ring gear 33b is permanently connected to the housing 27/the support region 32 fixed to the housing.

In the second exemplary embodiment shown in FIG. 2, an alternative design of the drive system 1 according to the disclosure can be seen. The basic structure of this second exemplary embodiment is the same as that of the first exemplary embodiment, so for reasons of brevity only the differences between these two exemplary embodiments are described below.

In FIG. 2, the output shaft 36 of the transmission device 16 is coupled to a further second differential transmission 13 (front wheel differential), implementing an all-wheel drive. In this context, it should be noted that in a further embodiment of the drive system 1 according to the disclosure, there is also only the second differential transmission 13, i.e. without the first differential transmission 12, implementing a front-wheel drive.

In FIG. 2, the output shaft 36 of the transmission device 16 is rotationally connected to an intermediate shaft 20 via a first gearing stage 17 (in the form of a spur gear gearing stage). The intermediate shaft 20 is arranged parallel to the rotor shafts 4, 7. The intermediate shaft 20 is connected to an input 15 of the second differential transmission 13 via a further second gearing stage 18, here in the form of a bevel gearing. Consequently, the input 15 is realized as a bevel gear. Thus, there is also a permanent rotational coupling of the second rotor shaft 7 with the input 15 of the second differential transmission 13. The rotary connection of the second rotor shaft 7 with the input 15 of the second differential transmission 13 is thus implemented via the transmission device 16, the intermediate shaft 20 and the two first and second gearing stages 17, 18.

The two outputs 11a, 11b of the second differential transmission 13 are also aligned obliquely, specifically substantially perpendicularly, to the rotor shafts 4, 7 and the output shaft 5 of the internal combustion engine 3. In this context, it should be noted for the sake of completeness that the illustration according to FIG. 2 is to be understood in such a way that the first output 11a of the second differential transmission 13 crosses the first rotor shaft 4 below or above the drawing plane, so that of course the first rotor shaft 4 is not directly connected to the first output 11a.

In other words, a two-speed dedicated hybrid transmission for power shifting is thus implemented according to the disclosure for a drive train in front-longitudinal configuration. In particular, the internal combustion engine 3 is installed longitudinally. In addition, a clutch 8 is inserted between the E-machines 6, 9.

Furthermore, the first electric machine 6 is geared to a higher speed via a stationary gear ratio 42 (e.g. planetary stage). The first electric machine 6 is directly connected to the second electric machine 9 via the clutch 8. The second electric machine 9 is geared back to low speeds via a combination of stationary gear ratios (e.g. planetary stages 29, 30). A gearing from the internal combustion engine 3 to the differential 12, 13 is thus directly implemented, i.e. about 5.9 and 2.8. The two gears are made possible by actuating the brake 31 or the clutch 34. The two gears allow the second electric machine 9 to be dimensioned smaller (torque and speed). This is an advantage for vehicles with high requirements in terms of Vmax and start-up performance.

FIG. 1 shows a structure according to the disclosure in which the first electric machine 6 is also geared to higher speeds. This can also be advantageous in order to increase the performance with the same installation space or to require less installation space for the same performance. The clutch 8 is located directly between the electric machines 6, 9 and only has to transmit a low torque due to the high drive.

A gearing of the three machines (3, 6, 9) to the wheel 24 is defined/fixed only by the two planetary sets 29 and 30 with the switching elements 31 and 34 and a fixed differential gear ratio.

FIG. 2 shows another possible configuration level with a longitudinal installation of the internal combustion engine 3 and front-wheel drive; optionally, all-wheel drive can also be represented by retaining the cardan shaft 23 and the rear-wheel differential 12. For front-wheel drive, torque is transmitted on a shaft 20 to the differential 13 via a transmission stage. For all-wheel drive, the gearing must be selected in any case such that the output speeds of both differentials 12, 13 are the same.

### LIST OF REFERENCE NUMBERS

1 Drive system
2 Motor vehicle
3 Internal combustion engine
4 First rotor shaft
5 Output shaft of the internal combustion engine
6 First electric machine
7 Second rotor shaft
8 Clutch
9 Second electric machine
10a First output of the first differential transmission
10b Second output of the first differential transmission
11a First output of the second differential transmission
11b Second output of the second differential transmission
12 First differential transmission
13 Second differential transmission
14 Input of the first differential transmission
15 Input of the second differential transmission
16 Transmission device
17 First gearing stage
18 Second gearing stage
19 Third gearing stage
20 Intermediate shaft
21 Torsional vibration damper
22 Vehicle longitudinal axis
23 Cardan shaft
24 Rear wheel
25 Front wheel
26 First stator
27 Housing
28 First rotor
29 First planetary transmission stage
30 Second planetary transmission stage
31 First switching element
32 Support region fixed to housing
33a First ring gear
33b Second ring gear
34 Second switching element
35 Input shaft
36 Output shaft of the transmission device
37 Second stator
38 Second rotor
39a First sun gear
39b Second sun gear
40a First planetary gear
40b Second planetary gear
41a First planetary carrier
41b Second planetary carrier
42 Fixed transmission stage
43 Third planetary carrier
44 Third sun gear
45 Third planetary gear
46 Third ring gear
47 Connecting shaft

1. A drive system for a hybrid motor vehicle, comprising an internal combustion engine, a first electric machine, a rotor shaft of the first electric machine is rotationally coupled to an output shaft of the internal combustion engine and arranged coaxially to said output shaft, a second electric machine, a rotor shaft of the second electric machine is arranged coaxially to the output shaft and configured to be uncoupled from the rotor shaft of the first electric machine via a clutch, and at least one differential transmission that has two outputs, wherein the output shaft is connected to the rotor shaft of the first electric machine via a fixed transmission stage, and the rotor shaft of the second electric machine is coupled to an input of the at least one differential transmission via a two-speed transmission device.

2. The drive system according to claim 1, wherein the fixed transmission stage is designed as a planetary transmission stage.

3. The drive system according to claim 1, wherein a planetary carrier of the fixed transmission stage is permanently connected to the output shaft of the internal combustion engine or a sun gear of the fixed transmission stage is connected to the first rotor shaft of the first electric machine.

4. The drive system according to claim 1, wherein the clutch is spatially arranged between rotors of the first and second electric machines.

5. The drive system according to claim 1, wherein the transmission device has two planetary transmission stages.

6. The drive system according to claim 5, wherein a first switching element of the transmission device is designed as a brake or is operatively inserted between a support region fixed to a housing and a ring gear of one of the planetary transmission stages.

7. The drive system according to claim 6, wherein a second switching element of the transmission device is designed as a clutch or is operatively inserted between an input shaft of the transmission device and a ring gear of one of the planetary transmission stages.

8. The drive system according to claim 1, wherein an output shaft of the transmission device is rotationally coupled to an input of a first differential transmission via a cardan shaft.

9. The drive system according to claim 8, wherein the output shaft of the transmission device is connected to an input of a second differential transmission via at least one gearing stage.

10. A motor vehicle with a drive system according to claim 1, wherein the output shaft of the internal combustion engine is arranged parallel or coaxial to a vehicle longitudinal axis of the motor vehicle.
